(19) United States
(12) Patent Application Publication
(10) Pub. No.: US 2003/0156571 A1
(43) Pub. Date: Aug. 21, 2003

(54) COMMUNICATIONS NETWORK AND METHOD FOR FRAMING POINT-TO-POINT FRAME STRUCTURES

(76) Inventor: HANS-AKE LUND, BOHUS (SE)

Correspondence Address: JENKENS & GILCHRIST, PC, 1445 ROSS AVENUE, SUITE 3200, DALLAS, TX, 75202, US

(21) Appl. No.: 09/092,476

(22) Filed: Jun. 5, 1998

(51) Int. Cl. H04J 3/24

(52) U.S. Cl. 370/349

(57) ABSTRACT

A communications network and method is provided for framing point-to-point frame structures to minimize the overhead that consumes the bandwidth of a radio air interface located between a mobile station and a packet switched network. More specifically, the mobile terminal utilizes a serial interface and point-to-point protocol to connect to a data terminal, and a communication protocol and air interface to connect to the packet switched network. The mobile terminal inserts a first predetermined set of fields (overhead) onto a first frame structure (data) received from the packet switched network, and then forwards the inserted first frame structure (data and overhead) to the data terminal equipment. In addition, the mobile terminal removes a second predetermined set of fields (overhead) from a second frame structure (data and overhead) received from the data terminal, and then forwards the stripped second frame structure (data) to the packet switched network. Wherein the consumption of the bandwidth is minimized when the frame structures depending on the direction of travel are either stripped off or inserted with overhead fields such that mostly data is transmitted between the mobile terminal and the packet switched terminal.

### BACKGROUND OF THE INVENTION

1. Technical Field of the Invention

The present invention generally relates to the telecommunications field and, in particular, to a communications network and method for framing point-to-point frame structures to minimize overhead that consumes the bandwidth of a radio air interface located between a mobile station and a packet switched network.

2. Description of Related Art

The mobile terminals currently available to subscribers may have the capability to communicate within a communications network that supports packet switched communications. Packet switched communications transpire in a packet switched network and generally involve the Internet and data applications.

Communications networks/developers have predicted that packet switched communications will encompass a significant part of cellular traffic in the future. Consequently, a problem will likely occur where the bandwidth of a radio air interface between the packet switched network and the mobile terminal will be adversely consumed with overhead due to the framing of packet switched communications.

Referring to FIG. 1, there is illustrated a conventional communications network 100 where the bandwidth within a radio air interface 101 between the packet switched network 102 and the mobile terminal 104 is consumed with overhead 105 due to the transmission of full point-to-point frame structures 106 (one shown). The full point-to-point frame structures 106 often have High Level Data Control Link (HDLC)—like framing. In addition, the mobile terminal 104 utilizes full point-to-point frame structures 122 (one shown) including overhead fields 124 to communicate over a serial interface 107 with a data terminal equipment 108.

The full point-to-point frame structure 106 includes several fields such as a first flag sequence field 110, an address field 112, a control field 114, an encapsulated point-to-point frame 116, a frame check sequence field 118 and a second flag sequence field 120. The encapsulated point-to-point frame 116 contains the actual data to be communicated between the packet switched network 102 and the data terminal equipment 108 by way of the mobile terminal 104. Unfortunately, the remaining fields 110, 112, 114, 118 and 120 include several bytes of data considered to be overhead 105 in that they consume the bandwidth within the radio air interface 101 located between the packet switched network 102 and the mobile terminal 104.

Accordingly, there is a need for a method and communications network for framing point-to-point frame structures to minimize overhead that consumes the bandwidth of a radio air interface located between a mobile station and a packet switched network. This and other needs are satisfied by the communications network and method of the present invention.

### SUMMARY OF THE INVENTION

The present invention is a method and communications network capable of framing point-to-point frame structures to minimize the overhead that consumes the bandwidth of an air interface located between a mobile station and a packet switched network. More specifically, the mobile terminal utilizes a serial interface and point-to-point (“PPP”) protocol to connect to a data terminal, and a communication protocol and radio air interface to connect to the packet switched network. The mobile terminal inserts a first predetermined set of fields (overhead) onto a first frame structure (data) received from the packet switched network, and then forwards the inserted first frame structure (data and overhead) to the data terminal. In addition, the mobile terminal removes a second predetermined set of fields (overhead) from a second frame structure (data and overhead) received from the data terminal, and then forwards the stripped second frame structure (data) to the packet switched network. Wherein the consumption of the bandwidth is minimized when the frame structures depending on the direction of travel are either stripped off or inserted with overhead fields such that mostly data is transmitted between the mobile terminal and the packet switched terminal.

In accordance with the present invention a communications network and method are provided that can be implemented in a cellular system such as a Packet Personal Digital Cellular (PPDC) System.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 (prior art) is a diagram of a frame structure in a conventional communications network where the bandwidth between a packet switched network and a mobile terminal is consumed with overhead due to the transmission of full point-to-point frame structures;

FIG. 2 is a diagram of a communications network for framing point-to-point frame structures in accordance with the present invention;

FIG. 3 is a diagram illustrating in greater detail the point-to-point frame structures transmitted from the packet switched network to the mobile terminal and then forwarded from the mobile terminal to the data terminal equipment;

FIG. 4 is a diagram illustrating in greater detail the point-to-point frame structures transmitted from the data terminal equipment to the mobile terminal and then forwarded from the mobile terminal to the packet switched network; and

FIG. 5 is a simplified flow diagram of a procedure for framing point-to-point frame structures.

### DETAILED DESCRIPTION OF THE DRAWINGS

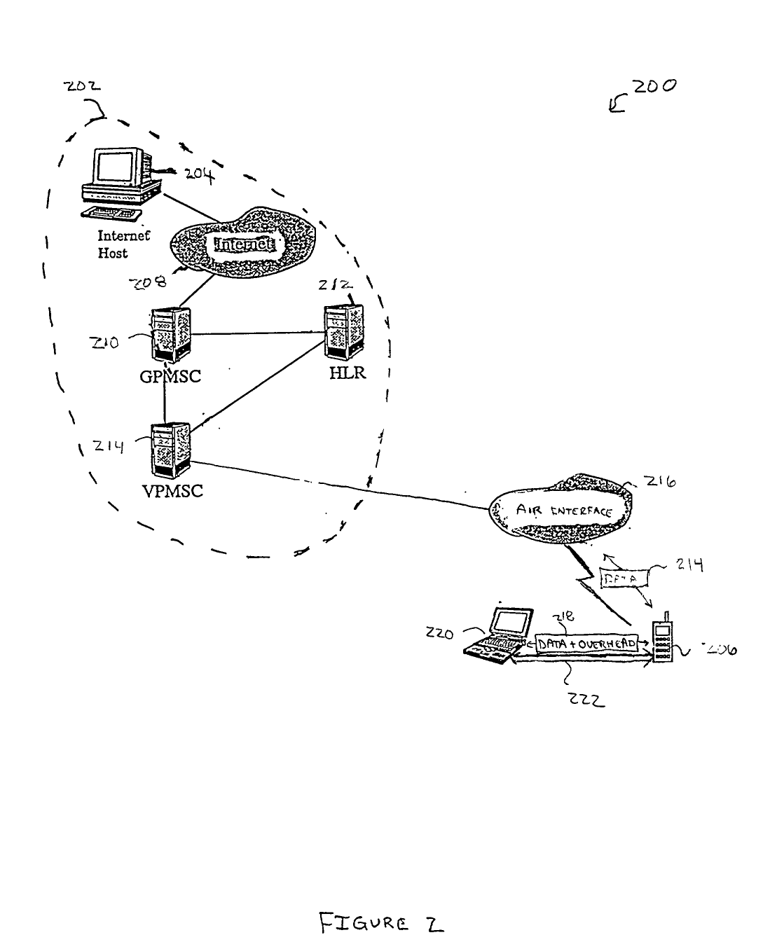

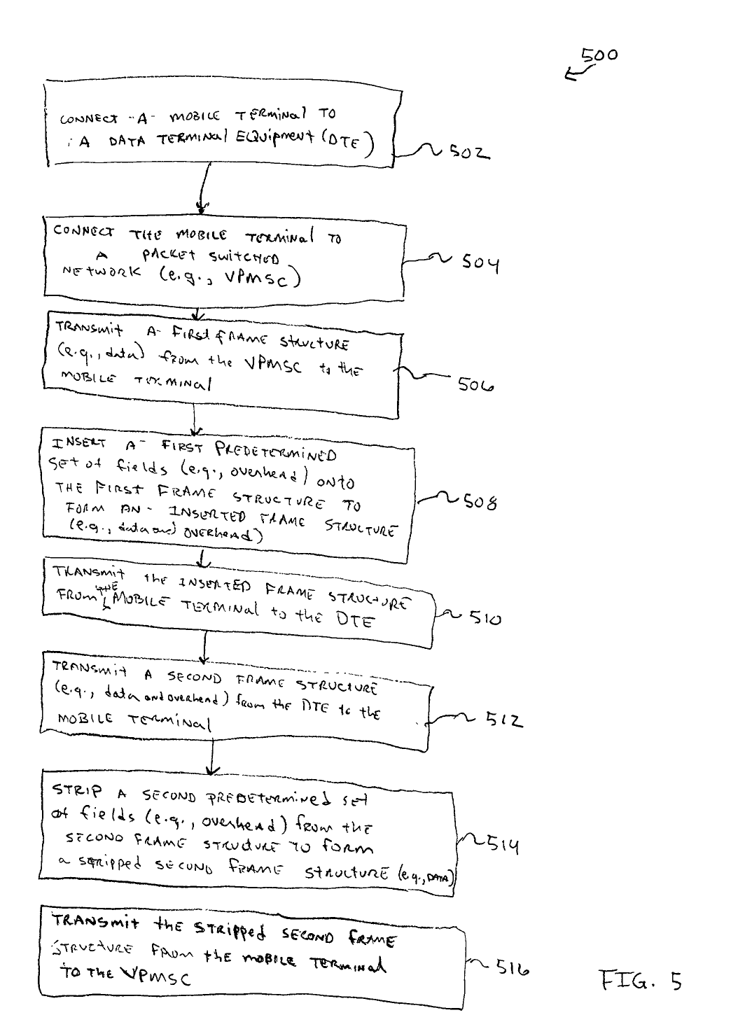

Referring to the Drawings, wherein like numerals represent like parts throughout FIGS. 2-5, there are disclosed two embodiments of an exemplary communications network 200 (FIGS. 2-4) and a framing method 500 (FIG. 5) in accordance with the present invention. Although the communications network 200 will be discussed based on the PPDC specification, it should be understood that the PPDC specification is only one of many specifications and standards that may utilize the principles of the present invention. For example, the communications network 200 may be utilized in a variety of standards including the Global System for Mobile Communications (GSM) specification and the General Packet Radio Service (GPRS) specification. Accordingly, the communications network 200 should not be construed in such a limited manner.

Referring to FIG. 2, there is illustrated a diagram of the exemplary communications network 200 in accordance with the present invention. In order to better present and describe the preferred embodiment of the present invention, a detailed discussion regarding the point-to-point frame structures (e.g., for packet switched communications) and framing of such structures will be deferred pending a description of the general architecture of the communications network 200.

The communications network 200 includes a packet switched network 202 and may include a circuit switched network (not shown). The packet switched network 202 includes an Internet host 204 (e.g., fixed terminal) capable of communicating with a mobile terminal 206 through an Internet network 208. The Internet network 208 connects to a gateway packet mobile services switching center (GPMSC) 210 that communicates with a home location register (HLR) 212. The GPMSC 210 also connects to a visited packet mobile services switching center (VPMSC) 214. There may be multiple VPMSC's 214 located in the packet switched network 202, wherein all of the VPMSCs would communicate with the GPMSC 210.

The VPMSC 214 and the mobile terminal 206 can communicate by transmitting a frame structure 214 (e.g., including data) in either direction over a conventional radio air interface 216 using a conventional communications protocol. In contrast, the mobile terminal 206 and a data terminal equipment (DTE) 220 (e.g., data terminal) can communicate by transmitting another frame structure 218 (e.g., including data and overhead) in either direction over a serial interface 222 or an emulated serial interface using a PPP protocol. In the alternative, the mobile terminal 206 may incorporate a DTE instead of connecting to the DTE 220 (as shown).

The serial interface 222 can be arranged in accordance with the International Telecommunication Union-Telecommunication Standards Section (ITU-T) V.25 standard or in accordance with any of the Electronic Industries Association's (EIA's) recommended standards including RS-232-E and RS-422. Furthermore, It should be noted that the communications network 200 is capable of supporting multiple mobile terminals 206 and DTEs 220 at any given time; however, for clarity only one mobile terminal and one DTE are discussed.

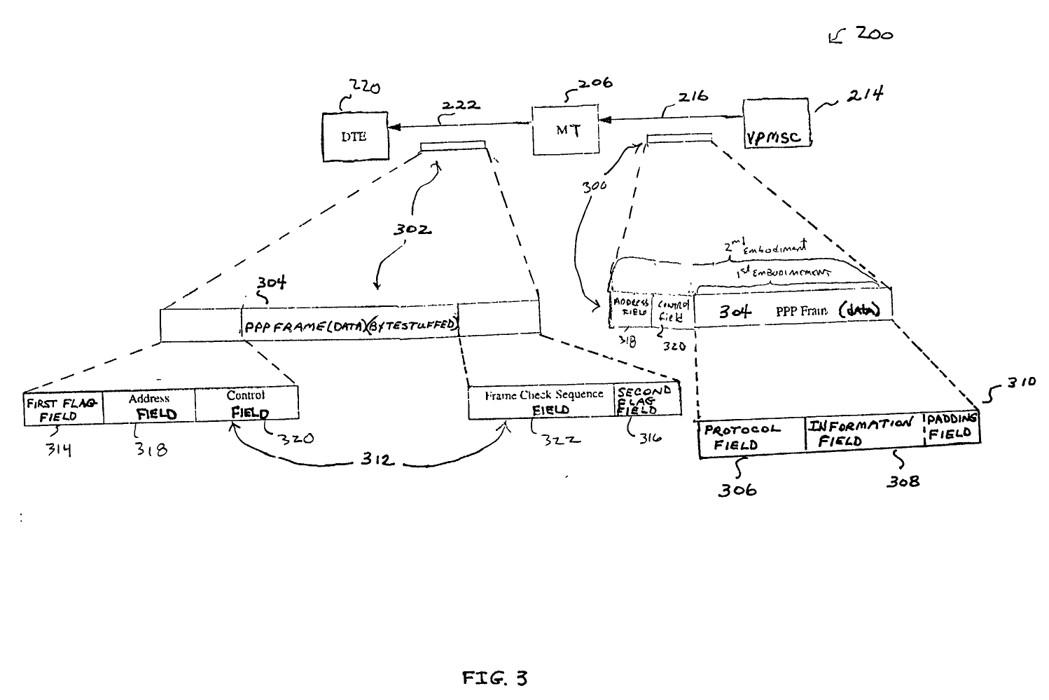

At this point it may be beneficial to reclarify that one aspect of the present invention is to frame point-to-point frame structures (e.g., frame structure 214) in order to minimize the overhead that consumes the bandwidth within the radio air interface 216 between the mobile station 206 and the VPMSC 214. To that end, a detailed discussion of the point-to-point frame structures (e.g., structures 214 and 218) transmitted between the DTE 220 and the VPMSC 214 by way of the mobile terminal 206 is provided below with reference to FIGS. 3-5.

Referring to FIG. 3, there is a diagram illustrating point-to-point frame structures 300 and 302 that are respectively transmitted from the VPMSC 214 to the mobile terminal 206, and then forwarded from the mobile terminal to the DTE 220. The point-to-point frame structures 300 and 302 (e.g., structures 214 and 218 'FIG. 2) are referred herein as the first frame structure 300 and the inserted frame structure 302.

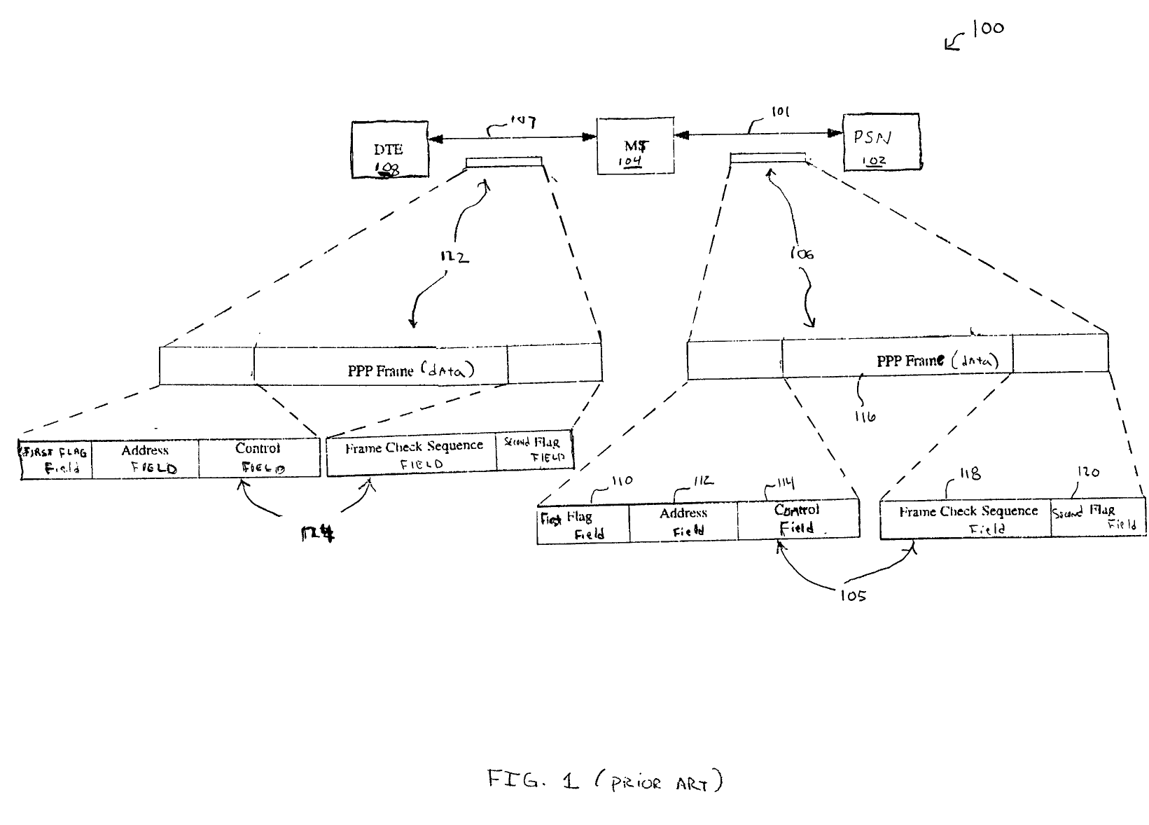

In a first embodiment, the first frame structure 300 can be transmitted from the VPMSC 214 to the mobile terminal 206 over a “transparent” datapath within the radio air interface 216 and includes only an encapsulated point-to-point frame 304 as compared to the full point-to-point frame structure 106 (FIG. 1). The VPMSC 214 is able to transmit the encapsulated point-to-point frame 304 instead of the full point-to-point frame structure 106, because the radio air interface 216 and corresponding communication protocol are able to frame and provide error correction for the first frame structure 300.

The encapsulated point-to-point frame 304 has a protocol field 306 and an information field 308. The protocol field 306 generally contains one or two octets for identifying a datagram (packet data) encapsulated in the information field 308. The information field 308 can have multiple octets for containing the datagram specified in the protocol field 306. In addition, the information field 308 may include a padding field 310 having at least 1500 octets that are distinguished from the real information (e.g., packet data) by the point-to-point protocol.

Upon receiving the first frame structure 300, the mobile terminal 206 operates to insert a first predetermined set of fields 312 (e.g., overhead) onto the encapsulated point-to-point frame 304 to form the inserted frame structure 302. The mobile terminal 206 then transmits the inserted frame structure 302 to the DTE 220 utilizing the serial interface 222 and the point-to-point protocol.

The first predetermined set of fields 312 include a first flag sequence field 314 and a second flag sequence field 316 that are preferably located at opposite ends of the inserted frame structure 302. Each of the first and second flag sequence fields 314 and 316 generally contain a binary sequence “01111110” (hexadecimal 0x7e) used to synchronize the frames.

The first predetermined set of fields 312 further include an address field 318 and a central field 320, where the address field has a single octet positioned adjacent to the first flag sequence field 314. The address field contains another binary sequence “11111111” (hexadecimal 0xff) for addressing a particular termination point (e.g., DTE 220 or the VPMSC 214) within the communications network 200. The control field 320 is located between the address field 318 and the encapsulated point-to-point frame 304 and includes a single octet having a defined value. It should be noted that the address field 318 and the control field 320 can be added even if the DTE 220 and the VPMSC 214 have negotiated to compress the address and control fields.

The first predetermined set of fields 312 also includes a 16-bit frame check sequence field 322 positioned between the encapsulated point-to-point frame 304 and the second flag sequence field 316.

The mobile terminal 206 may be required to alter the encapsulated point-to-point frame 304 by a process known as byte-stuffing which includes escaping or quoting of control characters. The byte-stuffing operation is required even when the mobile terminal 206 is not aware that an Asynchronous-Control-Character-Map (ACCM) has been negotiated between the DTE 220 and the VPMSC 214. For example, all of the control characters between 0x00 and 0x1f (hexadecimal) are escaped due to a default behavior of an asynchronous link in the PPP.

In a second embodiment, the first frame structure 300 includes the address field 318 and the control field 320 in addition to the encapsulated point-to-point frame 304. In such a situation, the address field 318 and control field 320 are not included in the first predetermined set of fields 312. Otherwise, the first and second embodiments are essentially the same.

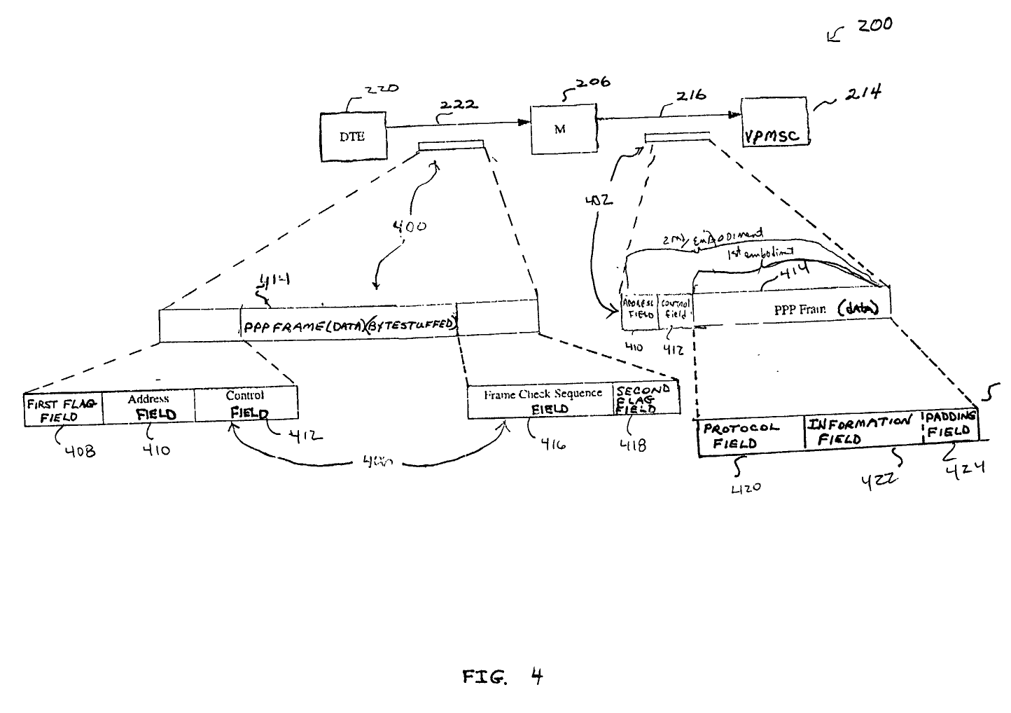

Referring to FIG. 4, there is a diagram illustrating point-to-point frame structures 402 and 404 respectively transmitted from the DTE 220 to the mobile terminal 206 and then forwarded from the mobile terminal to the VPMSC 214. The point-to-point frame structures 400 and 402 (e.g., structures 214 and 218 'FIG. 2) are referred herein, respectively, as the second frame structure 400 and the stripped frame structure 402.

In the first embodiment, the second frame structure 400 is transmitted from the DTE 220 to the mobile terminal 206 over the serial interface 222 using the PPP. The second frame structure 400 is similar to the inserted frame structure 302 (FIG. 3), because the second frame structure 400 includes a second predetermined set of fields 406 (e.g., overhead) such as a first flag sequence field 408, an address field 410, a control field 412, a frame check sequence field 416 and a second flag sequence field 418.

The second predetermined set of fields 406 is similar to the first predetermined set of fields 312 and as such a detail description about each field will not be repeated. Likewise, an encapsulated point-to-point frame 414 (byte-stuffed) is similar to the encapsulated point-to-point frame 304 (non-byte-stuffed 'FIG. 3). The encapsulated point-to-point frame 414 is a component of the second frame structure 402 and includes a protocol field 420, information field 422 and a padding field 424.

Upon receiving the second frame structure 402, the mobile terminal 206 operates to strip the second predetermined set of fields 406 from the second frame structure 402 to form the stripped second frame structure 404. In addition, any escape characters may also be stripped by the mobile terminal 206. The stripped second frame structure 404 is similar in form to the first frame structure 300.

In a second embodiment, the stripped second frame structure 402 includes the address field 410 and the control field 412 in addition to the encapsulated point-to-point frame 414. In such a situation, the address field 410 and control field 412 are not included in the second predetermined set of fields 406. Otherwise, the first and second embodiments are essentially the same.

Thereafter, the mobile terminal 206 operates to transmit the stripped second frame structure 402 to the VPMSC 214 over the transparent datapath within the air interface 216. The stripped second frame 402 includes the encapsulated point-to-point frame 414. The mobile terminal 206 is able to transmit the encapsulated point-to-point frame 414 instead of the full second frame structure 402, because the radio air interface 216 and corresponding communication protocol are able to frame and provide error correction for the stripped second frame 402 structure.

Additional information associated with the first and second predetermined sets of fields 312 and 406, the PPP, the ACCM, and HDLC-like framing can be found in the publications entitled “The Point-to-Point Protocol (PPP)”, STD 51, RFC 1661, July 1994, and “PPP in HDLC-like Framing”, STD 51, RFC 1662, July 1994, both of which were edited by W. Simpson and are hereby incorporated by reference into this specification.

Referring to FIG. 5, there is a simplified flow diagram of the framing method 500 used to frame point-to-point frame structures. Beginning at stage 502 of the framing method 500, the mobile terminal 206 and the DTE-220 are connected using the serial interface 222 and the point-to-point protocol. Likewise at stage 504, the mobile terminal 206 and the packet switched network 102 and, more specifically, the VPMSC 214 are connected using the communications protocol and the radio air interface 216. At this point, the DTE 220 and the VPMSC 214 can negotiate link control protocol (LCP) options.

At stage 506, the VPMSC 214 transmits the first frame structure 300 to the mobile terminal 206. In the first above-mentioned embodiment, the first frame structure 300 includes the encapsulated point-to-point frame 304 (e.g., packet data). Whereas, the first frame structure 300 in the second embodiment includes the encapsulated point-to-point frame 304, the address field 318 and the central field 320.

At stage 508, the mobile terminal 206 operates to insert the first predetermined set of fields 312 onto the first frame structure 300 to form the inserted frame structure 302. The inserted frame structure 302 is then transmitted on the serial interface 222 from the mobile terminal 206 to the DTE 220, at stage 510. The first predetermined set of fields 312 includes the first and second flag sequence fields 314 and 316, the frame check sequence frame 322, the address field 318 (first embodiment), and the control field 320 (first embodiment).

At stage 512, the DTE 220, in addition to receiving the inserted frame structure 302, can also transmit packet switched communications having the form of the second frame structure 402 to the mobile terminal 206.

At stage 514, the mobile terminal 206 operates to strip the second predetermined set of fields 406 from the second frame structure 402 to form the stripped second frame structure 404 (e.g., first or second embodiment). The stripped frame structure 404 is then transmitted over the radio air interface 216 from the mobile terminal 206 to the VPMSC 214, at stage 516.

From the foregoing, it can be readily appreciated by those skilled in the art that the present invention provides a method and communications network for framing point-to-point frame structures to minimize the overhead within bandwidth in the air interface between the mobile station and the packet switched network. To minimize the consumption of the bandwidth, the frame structures depending on the direction of travel are either stripped off or inserted with overhead fields such that mostly data is transmitted between the mobile terminal and the packet switched terminal.

Although two embodiments of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions as may be included in the spirit and scope of the invention as defined in the following claims.

What is claimed is:

1. A communications network comprising:
a data terminal;
a mobile terminal using a first interface and a first protocol to connect with the data terminal;
a packet switched network using an air interface and a second protocol to connect with the mobile terminal; and
said mobile terminal operable to insert a first predetermined set of fields onto a first frame structure received from the packet switched network, forward the inserted first frame structure to the data terminal equipment, strip a second predetermined set of fields from a second frame structure received from the data terminal equipment, and forward the stripped second frame structure to the packet switched network.

2. The communications network of claim 1, wherein said first frame structure and said stripped second frame structure each include an encapsulated point-to-point frame comprising a protocol field and an information field.

3. The communications network of claim 2, wherein said information field further includes a datagram associated with the protocol field and a padding octet.

4. The communications network of claim 1, wherein each of the first and second predetermined sets of fields further includes at least one of a first flag sequence field, a frame check sequence field and a second flag sequence field.

5. The communications network of claim 4, wherein each of the first and second predetermined sets of fields further includes at least one escape character.

6. The communications network of claim 4, wherein each of the first and second predetermined sets of fields further includes an address field and a control field.

7. The communications network of claim 1, wherein said first interface further includes a selected one of a serial interface and an emulated serial interface.

8. The communications network of claim 1, wherein said first protocol further includes a point-to-point protocol transmitted over an asynchronous link.

9. The communications network of claim 1, wherein said air interface further comprises datapath.

10. The communications network of claim 1, wherein said second protocol further includes a Call Control protocol layer.

11. A communications network for framing point-to-point frame structures, said communications network comprising:
a data terminal;
a mobile terminal using a serial interface and a point-to-point protocol to connect with the data terminal;
a packet switched network using an air interface and a communications protocol to connect with the mobile terminal; and
said mobile terminal operable to insert a first plurality of fields onto a first frame structure received from the packet switched network, forward the inserted first frame structure to the data terminal equipment, strip a second plurality of fields from a second frame structure received from the data terminal equipment, and forward the stripped second frame structure to the packet switched network.

12. The communications network of claim 11, wherein said first frame structure further includes an encapsulated point-to-point frame comprising a protocol field and an information field.

13. The communications network of claim 12, wherein said inserted first frame structure further includes at least one of a first flag sequence field, a frame check sequence field, a second flag sequence field and the encapsulated point-to-point frame.

14. The communications network of claim 13, wherein said inserted first frame structure further includes at least one escape character.

15. The communications network of claim 13, wherein said inserted first frame structure further includes an address field and a control field.

16. The communications network of claim 11, wherein said second frame structure further includes at least one of a first flag sequence field, a frame check sequence field, a second flag sequence field and an encapsulated point-to-point frame.

17. The communications network of claim 16, wherein said second frame structure further includes at least one escape character.

18. The communications network of claim 16, wherein said second frame structure further includes an address field and a control field.

19. The communications network of claim 11, wherein said stripped second frame structure further includes an encapsulated point-to-point frame having a protocol field and an information field.

20. The communications network of claim 19, wherein said information field further includes a datagram associated with the protocol field and a padding octet.

21. A method used in a communications network for framing point-to-point frame structures, said method comprising the steps of:
connecting a mobile terminal to a data terminal using a serial interface and a point-to-point protocol;
connecting a packet switched network to the mobile terminal using an air interface and a communications protocol;
transmitting a first frame structure from the packet switched network to the mobile terminal;
receiving the transmitted first frame structure within the mobile terminal;
inserting a first plurality of fields onto the received first frame structure; and
forwarding the inserted first frame structure to the data terminal.

22. The method of claim 21, further comprising the steps of:
transmitting a second frame structure from the data terminal to the mobile terminal;
receiving the transmitted second frame structure within the mobile terminal;
stripping a second plurality of fields from the received second frame structure; and
forwarding the stripped second frame structure to the packet switched network.

23. The method of claim 22, wherein the step of inserting a first plurality of fields further includes adding at least one of a first flag sequence field, a frame check sequence field and a second flag sequence field.

24. The method of claim 23, wherein the step of adding further includes adding an address field and a control field.

25. The method of claim 24, wherein the step of adding an address field and a control field further includes compressing the address field and the control field.

26. The method of claim 24, wherein the step of adding an address field and a control field further includes quoting a plurality of control characters.

27. The method of claim 22, wherein the step of stripping a second plurality of fields further includes removing at least one of a first flag sequence field, a frame check sequence field and a second flag sequence field.

28. The method of claim 27, wherein the step of removing further includes removing an address field and a control field.

29. The method of claim 27, wherein the step of stripping a second plurality of fields further includes translating at least one of an escaped first flag sequence, an escaped second flag sequence, and quoted control characters to unescaped first flag sequences, an unescaped second flag sequence, and unescaped control characters, respectively.

30. The method of claim 21, further comprising the step of negotiating link control protocol options between the data terminal equipment and the packet switched network.
